(19) United States
(12) Patent Application Publication
(10) Pub. No.: US 2006/0256189 A1
(43) Pub. Date: Nov. 16, 2006

(54) Customized insertion into stock media file

(76) Inventor: Win Crofton, Sudbury, MA (US)

Correspondence Address: FISH & RICHARDSON PC, P.O. BOX 1022, MINNEAPOLIS, MN, 55440-1022, US

(21) Appl. No.: 11/127,530

(22) Filed: May 12, 2005

(51) Int. Cl. H04N 7/14

(52) U.S. Cl. 348/14.15

(57) ABSTRACT

A method for creating customized audiovisual-media, the method including receiving customer-supplied information, selecting a script having instructions for combining at least part of the customer-supplied information with computer-generated media or stock media, and executing the script.

### TECHNICAL FIELD

This invention relates to digital media, and more particularly to generation of audiovisual media.

### BACKGROUND

People in general, and small children in particular, often like to see themselves in unexpected contexts, such as on a television screen. Indeed, small children may be endlessly amused by seeing images of themselves in unusual situations. Placing children's pictures on novelty items, cups, mousepads, etc., is well known in the art.

Moving pictures, however, are a source of even greater fascination for children. Thus, rather than place children's static pictures on static objects, however, one might instead create customized audiovisual media using customer-supplied information. Using this method, a parent might incorporate a video of a child, along with other information about the child, into a prefabricated video in order in order to obtain customized audiovisual media containing the child in an unexpected setting. However, the process of creating such customized audiovisual media can be laborious.

### SUMMARY

In one aspect, in general, the invention features a method for creating customized audiovisual-media, the method comprising receiving customer-supplied information, selecting a script including instructions for combining at least part of the customer-supplied information with computer-generated media or stock media, and executing the script.

Implementations may include one or more of the following features. The script further includes instructions for selecting the computer-generated or stock media at least in part on the basis of the customer-supplied information. The method further comprises retrieving the computer-generated or stock audiovisual media from a database. The method further comprises causing a computer to generate the computer-generated or stock audiovisual media. Receiving customer-supplied information comprises receiving customer-supplied audiovisual media and customer-supplied non-audiovisual information. Selecting a script comprises selecting a script in which the instructions for creating the customized audiovisual media comprise instructions for combining the customer-supplied audiovisual media and the computer-generated or stock audiovisual media. Selecting a script comprises selecting a script in which the instructions for creating the customized audiovisual media comprise instructions for incorporating elements from the customer-supplied information into the computer-generated or stock audiovisual media.

In one aspect, in general, the invention features an apparatus for creating customized audiovisual media, comprising means for receiving customer-supplied information, means for selecting a script including instructions for combining at least part of the customer-supplied information with computer-generated or stock media, and means for executing the script.

In one aspect, in general, the invention features an apparatus for creating customized audiovisual media based on computer-generated or stock audiovisual media and customer-supplied information, comprising a production line having instructions to create the customized audiovisual media, a line controller having instructions to control the production line, and a factory controller having instructions to send the customer-supplied information to the line controller.

Implementations may include one or more of the following features. The factory controller, the line controller, and the production line each comprise a computer. The production line comprises a plurality of computer organized to process data in a pipeline.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram depicting one embodiment of a media generator.

FIG. 2 is a flowchart of a procedure carried out in one embodiment of the invention.

FIG. 3 is a flowchart of a procedure carried out in one embodiment of the invention.

FIG. 4 is a flowchart of a procedure carried out in one embodiment of the invention.

Like reference symbols in the various drawings indicate like elements.

### DETAILED DESCRIPTION

Described below are embodiments relating to a system and method for creating customized multimedia clips, geared toward small children, in which customer-specific information, including customer-supplied audiovisual media, are integrated into the final product. Although the described embodiments relate primarily to children's videos, multimedia presentations of all sorts, and for all audiences, are also contemplated.

As used herein, the term “video” includes, in addition to its ordinary meaning, still images. As used herein, the term “audiovisual media” includes digital or analog information that includes a video component and/or an audio component. One example, used throughout, is a digital multimedia clip, but this example should not be considered to limit the scope of the claims. The term “customer” refers to any natural person.

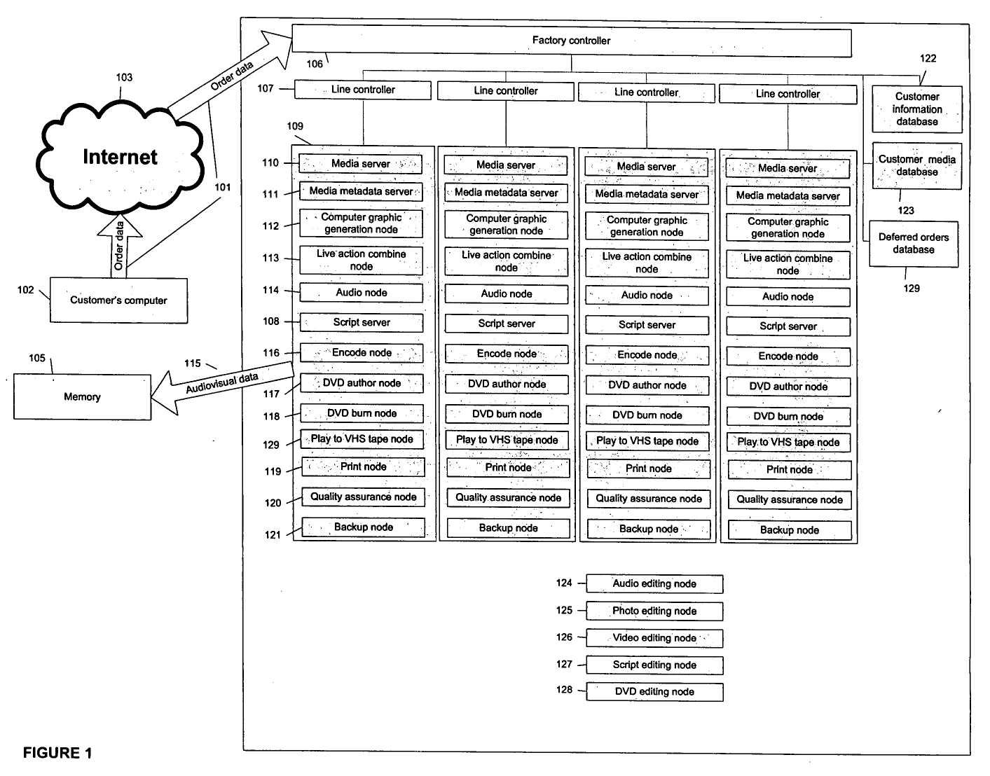

Referring to FIG. 1, in one embodiment of the invention, a customer uses a home computer 102 to supply information, such as an order 101 for a customized home video, to a media generator 104 in data communication with the computer 103, for example over the internet 103. The media generator 104 processes the order 101 by selecting an appropriate script from a script database 108. Based on the instructions in the script and information in the order 101, the media generator 104 creates a list of stock media clips.

The stock media clips comprise prefabricated, generic audiovisual-media. These clips are retrieved from a clip database 110 of stock clips. The media generator also creates computer-generated media clips based on instructions in the script and information from the order 101. The media generator 104 then duplicates the selected stock clips and modifies the copy based on information in the order 101. The media generator 104 also modifies the generated clips based on information in the order 101. The media generator 104 combines these modified clips, creating the customized audiovisual-media 115, and stores that data 115 in a memory 105. The memory 105 may be, for example, a DVD, a VHS cassette tape, a mini-DV, digital video disk, or a CD-ROM disc containing a computer program, such as a game, that incorporates the customized audiovisual-media 115. In such cases, the memory recording 105 is then mailed to the customer. In an alternative embodiment, the media generator 104 stores the customized data 115 in RAM or on a hard drive. In such cases, the media generator 104 delivers the customized data to the customer electronically, for example over the internet.

In some examples, the information contained in a customer order 101 includes customer-supplied non-audiovisual information, such as: family last name; number of family members; names of family members; number and type of family pets; name of child who will be receiving this product; age of child; nationality; religion; ethnic background; color; race; and language spoken. In some examples, different information is included. The customer order 101 also optionally includes customer-supplied audiovisual media to be incorporated into the customized audiovisual-media 115, such as still pictures, audio clips, or audiovisual clips.

In an embodiment shown in FIG. 1, the media generator 104 includes a factory controller 106 for controlling one or more line controllers 107. The media generator 104 also includes a number of nodes (in this embodiment, separate computer systems) dedicated to certain predefined tasks. Some of these nodes are organized into production lines 109, each of which is under control of a line controller 107. The media generator 104 also includes nodes not associated with a production line 109, such as: a customer information database 122, containing customer information derived from the customer order 101; and a customer media database 123, containing photo, video, audio and other multimedia data provided by the customer. When an order 101 is received, the factory controller 106 assigns the order to a line 109 based upon existing lines' operational capacity. If all lines 109 are running at capacity, the factory controller 106 may prompt an administrator to enable a new line 109, for example by turning on the computers associated with that line 109.

In the embodiment described in connection with FIG. 1, each node, including the factory controller 106 and line controllers 107, is a separate and distinct computer system. In other embodiments, however, the functionality of multiple nodes is assumed by a single computer system.

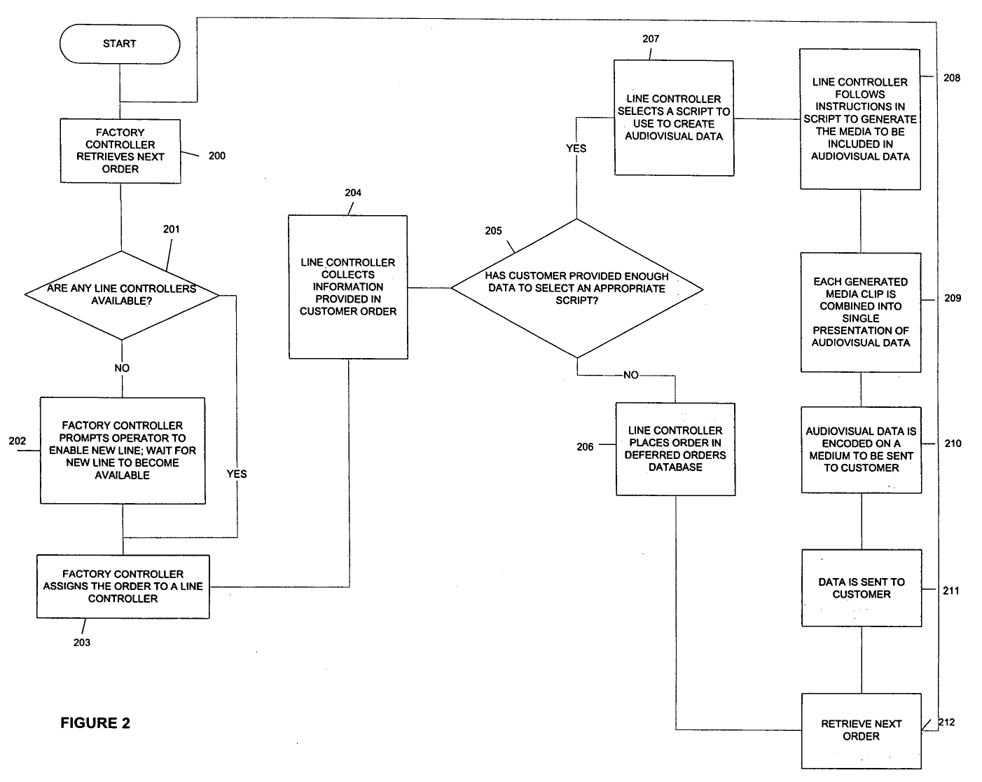

Referring also to FIG. 2, first, the factory controller 106 retrieves the next available order (step 200). It examines the status of the line controllers 107 to see if any line controllers 107 are available, i.e., not operating at maximum capacity (step 201). If not, the factory controller 106 prompts a human operator to enable a new line 109, and waits for the new line 109 to become available, or for an existing line 109 to become free (step 202). Next, the factory controller 106 assigns the order 101 to a line controller 107 (step 203). The line controller 107 then collects the information provided in the customer's order 101, including any multimedia data supplied by the customer (step 204). Next, the line controller 107 determines whether the customer has provided enough data to select an appropriate script (step 205). If not, the line controller 107 places the customer's order in a deferred orders database 129 so that the customer will be contacted to supply the missing information (step 206). If sufficient data is available, the line controller 107 selects a script to be used in creating the customized audiovisual-media 115 (step 207). Next, the line controller 107 follows the instructions in the script, based on the details provided in the customer's order 101, to generate the media clips to be included in the customized audiovisual-media 115 (step 208). Then, each of the generated media clips is combined, in an order specified by the script, to create the single customized audiovisual-media 115 (step 209). Finally, the customized audiovisual-media 115 is encoded on a medium 105 (step 210) and sent to the customer (step 211). In other examples, instead of steps 210 and 211, the line controller 107 places the order in a database. In some examples, the database is the deferred orders database 129; in other examples, it is a separate database. Later, the database is consulted (in some examples, by a human; in other examples, by a computer process), and the customer is contacted and instructed to download the customized audiovisual-media from a web server. In some examples, the medium 105 is a computer file.

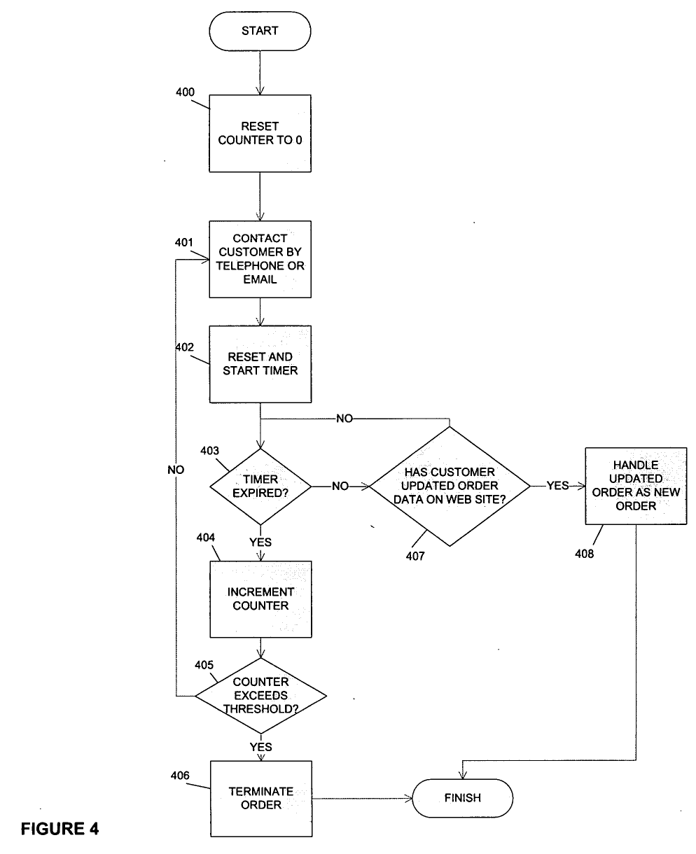

In some examples, the process by which a customer is contacted after an order is placed in the deferred orders database 129 in step 206 is as described in FIG. 4. In some examples, a person monitors the status of the database 129; in other examples, a computer process monitors this database 129. When a new order is placed in the database, first, the system (a person or computer) resets a counter to 0 (step 400). In some examples, the computer or person then sends email to the customer; in other examples, the person or computer telephones the customer (step 401). The call or email alerts the customer to check the status of their order online. Then a timer is reset and started (step 402). The system checks to see if the timer has expired (step 403). If so, the counter is incremented (step 404). The system then determines if the counter exceeds a predetermined threshold (e.g., 3) (step 405). If not, then the customer is contacted again (step 401). Otherwise, the order is terminated (step 406).

A customer who is successfully contacted visits a web site, as instructed. At the web site, the customer is instructed to provide the missing information.

If, in step 403, the timer has not expired, the system determines if the customer has updated the order information on the web site (step 407). If not, the system returns to step 403. If the customer has updated the order information, the newly-updated order is fed back to the factory controller 106 as a new order (step 408) by beginning the process described in FIG. 2 (step 200).In other examples, the customer supplies the information requested over the telephone or by mail instead of on the web.

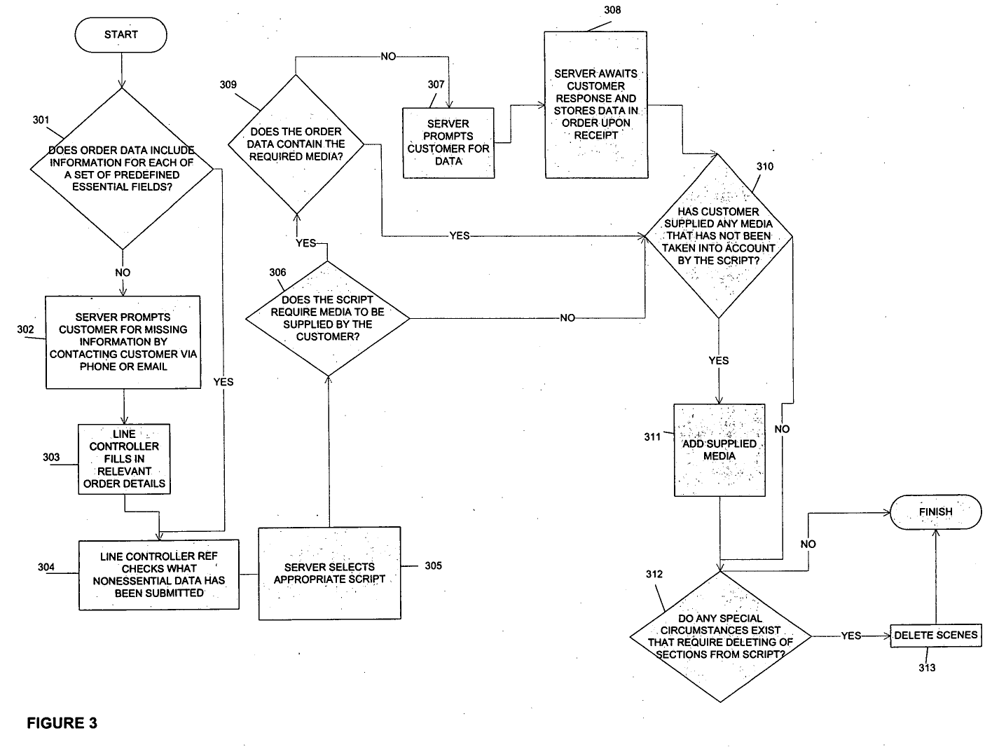

An appropriate script is selected in step 207 according to the algorithm described in FIG. 3. In step 301, the line controller 107 confirms that the order data 101 to see if it includes information for each of a set of predefined essential fields. These fields may include, for example, the name, age, and family composition of the individual for whom the multimedia presentation is being produced. If the controller 107 determines that any of the predefined essential fields is empty, then, in step 302, the line controller 107 prompts the customer for the missing information by contacting the customer by phone or email. Following receipt of a reply, the line controller 107 fills in the relevant order details in step 303. Once all the essential information is included, the line controller 107 checks, in step 304, what nonessential data has been submitted. Next, in step 305, the line controller selects an appropriate script by determining on each script whether the supplied data is that which the script requires.

Once a script is selected, the line controller checks to see if the script requires media, such as a photograph, to be supplied by the customer (step 306). If it does, the line controller checks to see if the order data 101 contains the required media (step 309). If not, the line controller prompts the customer for this the required media (step 307), and awaits the customer's response, storing the data in the order 101 when it is received (step 308).

Next, the line controller checks the order data 101 to see if the customer has supplied any media that is not already taken into account by the script (step 310). If so, the line controller instructs the script to take the additional media into account by adding scenes where appropriate (step 311). The line controller then checks the order data 101 to see if there exist special circumstances that require deleting sections from the script (step 312). This may occur, for example, in connection with single-parent households, non-traditional households and/or alternative child-raising environments. If appropriate, the line controller deletes sections from the script (step 313).

A line controller 107 controls all nodes in a line 109. Each line 109 includes a media server 404 having access to the clip database 110 containing stock prerecorded media clips (audio, video, photo) that does not come from the customer; a media metadata server 111 containing data necessary to make use of the stock clips provided by the media server; a computer-graphic generation node 112 generating computer-generated media, i.e., audiovisual sequences that are entirely computer-generated; a live-action combine node 113 for combining the order data 101 stock clips from media server 110; an audio node 114 for generating audio either by synthesizing audio or by combining order data 101 with stock clips; a script server 108 containing scripts; an encode node 116 for converting media from its native format to an output format, for example, MPEG2 format for DVDs; a DVD author node 117 for converting encoded media and other data to DVD format; a DVD bum node 118, for writing the data onto a DVD; a play to VHS tape node 129, for writing data onto a VHS tape; a print node 119 for printing the design and/or text on the surface of a DVD, and paper to associated with the DVD jacket/case/cover, or a label for a tape; a quality-assurance node 120, for checking the final product for defects; and a backup node 121, for backing up data.

As noted above, there exist nodes independent of any line 109. These include an audio editing node 124 for editing sections of stock audio clips; a photo editing node 125 to edit stock photographic files; a video editing node 126 to edit sections of stock video; a script editing node 127 to edit script files; and a DVD editing node 128 to edit the user-interface of the DVD.

In some embodiments, the line controller 107 coordinates the line to act as a pipeline. In this case, an order is processed in multiple stages, with the maximum amount of time required by each stage being the same. In some examples, some stages finish earlier than this maximum, but, in the embodiments described, no stage finishes later than he maximum. At time T, the line controller 107 sends a first order to the first stage of processing. At time T+1, the line controller 107 sends the first order, and any media generated by the first stage, to the second stage of processing, and sends a subsequent order to the first stage of processing. The process continues while orders remain to be processed or are proceeding through the pipeline.

In some embodiment, the function of some stages are accomplished by multiple computers operating in parallel. In some embodiments, a single computer performs the function of a stage for more than one line.

In one embodiment, the pipeline has five stages. In the first stage, the line controller 107 checks the order 101, selects a script, and prompts the customer for missing information. In the second stage, all required media is generated. In this stage, the following nodes run in parallel: five to fifteen computer-graphic generation nodes 112; five to fifteen live-action combine nodes 113; and one or two audio nodes 114. In the third stage, two to four encode nodes 116 execute in parallel to encode the media to the proper format. In the fourth stage, at least one of the DVD author node 117, the DVD burn node 118, or the play-to-VHS tape node 129 saves customized audiovisual-media 115 on a recording medium 105. In the fifth stage, the print node 119 prints labels and prepares the recording medium 105 for shipping.

A number of embodiments of the invention have been described. Nevertheless, it will be understood that various modifications may be made without departing from the spirit and scope of the invention. Accordingly, other embodiments are within the scope of the following claims.

What is claimed is:

1. A method for creating customized audiovisual-media, the method comprising:
receiving customer-supplied information;
selecting a script including instructions for combining at least part of the customer-supplied information with one of computer-generated media and stock media; and
executing the script.

2. The method of claim 1, wherein selecting a script comprises selecting a script in which the instructions comprise instructions for incorporating elements from the customer-supplied information into the one of computer-generated media and stock media.

3. The method of claim 1, wherein selecting a script comprises selecting a script further including instructions for selecting the one of computer-generated media and stock media at least in part on the basis of the customer-supplied information.

4. The method of claim 1, further comprising retrieving the one of computer-generated media and stock media from a database.

5. The method of claim 1, further comprising using a computer to generate the one of computer-generated media and stock media.

6. The method of claim 1, wherein receiving customer-supplied information comprises receiving customer-supplied audiovisual media and customer-supplied non-audiovisual information.

7. A system configured to execute the method recited in claim 1.

8. An apparatus for creating customized audiovisual media, comprising:
means for receiving customer-supplied information;
means for selecting a script including instructions for combining at least part of the customer-supplied information with one of computer-generated media and stock media; and
means for executing the script.

9. An apparatus for creating customized audiovisual media, the apparatus comprising:
a production line configured to execute instructions for creating the customized audiovisual media;
a line controller configured to execute instructions to control the production line; and
a factory controller configured to execute instructions to send the customer-supplied information to the line controller.

10. The apparatus of claim 9, wherein the factory controller, the line controller, and the production line each comprise a computer.

11. The apparatus of claim 9, wherein the factory controller, the line controller, and the production line each comprise a process executing on a computer.

12. The apparatus of claim 10, wherein the production line comprises a plurality of computers organized to process data in a pipeline.
